(19) United States
(12) Patent Application Publication
(10) Pub. No.: US 2009/0233065 A1
(43) Pub. Date: Sep. 17, 2009

(54) INK JET TREATMENT LIQUID, INK JET RECORDING METHOD, AND RECORDED MATTER

(75) Inventor: Hidehiko KOMATSU, Chino-shi (JP)

Correspondence Address: LADAS & PARRY, 26 West 61st Street, New York, NY, 10023, US

(73) Assignee: SEIKO EPSON CORPORATION

(21) Appl. No.: 12/404,367

(22) Filed: Mar. 16, 2009

(30) Foreign Application Priority Data
Mar. 17, 2008 (JP) 2008-068125

(51) Int. Cl. B32B 3/10; C08L 75/04; B05D 5/06

(52) U.S. Cl. 428/195.1; 525/453; 427/261

(57) ABSTRACT

An ink jet treatment liquid contains a cationic polyurethane and a polyamine and/or a polyamine derivative.

### BACKGROUND

1. Technical Field

The present invention relates to a coating suitable for ink-nonabsorbable films, and specifically to an ink jet treatment liquid, and an ink jet recording method and recoded matter using the ink jet treatment liquid.

2. Related Art

In the ink jet recording method, very small droplets are ejected from nozzles to deposit the droplets onto a recording medium, thereby recording images, letters, characters, and the like. The ink jet recording method makes it easy to increase printing speed, reduce noise, and form color images, and is capable of printing without contact with recording media. The ink jet recording method thus can be used in many recording apparatuses for various applications.

Particularly in the industry, a full-color ink jet recording method can produce image quality close to the quality of images formed by print plate process printing or silver halide photography, and besides can make a small number of copies at a lower cost than ordinary process printing. Accordingly, the application of the ink jet recording method is increasing.

Among applications in the industry is increasing the use for printing on labels and tags showing product description, design, product name, manufacturer name, or the like. This is because the ink jet recording method is suitable for printing a small number of copies.

However, general recording media for labels and tags are made of a nonabsorbable or absorption-retardant film, such as polyethylene terephthalate (PET), polyvinyl chloride (PVC), polypropylene (PP), or polyethylene (PE), from the viewpoint of glossiness, texture and necessary durability. These films are generally unsuitable for ink jet recording method.

In order to print on such nonabsorbable or absorption-retardant labels and tags, accordingly, an ink receiving layer is formed in advance on the media to prepare media suitable for ink jet recording.

In the invention, a pretreatment step of coating a recording medium by ejecting an ink jet treatment liquid onto the medium is added to the ink jet recording method, and thus makes it possible to print on nonabsorbable or absorption-retardant media, such as PET, PVC, PP, and PE films, by an ink jet printer.

The treatment liquid is required to have the following properties:
(1) reactive with the ink and capable of preventing the ink from spreading or bleeding;
(2) capable of coating film media, adhesive to the film media, and transparent after coating;
(3) not deteriorate with time and has storage stability;
(4) easy to dry after coating film media; and
(5) capable of ink jet ejection and not clog the ink jet head in practice.

However, no treatment liquid satisfying all of the above requirements has yet been developed. It is particularly difficult to provide a treatment liquid capable of ink jet ejection of requirement (5) while the properties of requirements (1) to (4) are satisfied. Also, the fact is that no treatment liquid has sufficient storage stability.

In order to enhance the ozone resistance while the occurrence of ink spreading is prevented, JP-A-2007-196395 discloses an ink jet recording medium containing a cationic polyurethane and a water-soluble metal salt including a divalent water-soluble magnesium salt and/or water-soluble calcium salt, and further containing a polyvinyl alcohol as a water-soluble binder and boric acid as a crosslinking agent.

This approach is intended to enhance the image quality by improving the recording media, and is not intended to pretreat the recording media by ink jet ejection. In addition, the approach is not suitable for ink jet ejection.

### SUMMARY

An advantage of some aspect of the invention is that it provides an ink jet treatment liquid that can be ejected by an ink jet method and is adhesive to ink-nonabsorbable recording media and transparent, and that can easily dry after being ejected and prevent printed images from spreading, and has storage stability.

As a result of intensive research, the inventors of the invention have found that an ink jet treatment liquid containing a cationic polyurethane and a polyamine and/or a polyamine derivative satisfies the above requirements.

According to an aspect of the invention, an ink jet treatment liquid is provided which contains a cationic polyurethane and a polyamine and/or a polyamine derivative.

The ink jet treatment liquid may further contain a long-chain alkyl glycol ether.

The ink jet treatment liquid may further contain a diacetylene tetraol expressed by general formula (1):

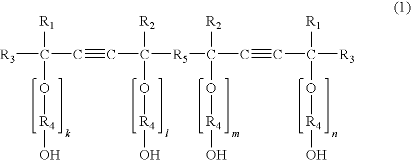

where R₁ and R₂ each represent an alkyl group having a carbon number in the range of 1 to 8; R₃ represents hydrogen or methyl; —O—R₄— independently represents one of oxyethyl, oxypropyl, and oxybutyl; R₅ represents a divalent linking group; and k, 1, m, and n each represent an integer in the range of 1 to 100.

The ink jet treatment liquid may further contain 1,2-alkanediol.

The ink jet treatment liquid may further contain a silicone surfactant.

According to another aspect of the invention, an ink jet recording method is provided which includes ejecting an ink jet recording ink onto a recording medium treated with the ink jet treatment liquid, thereby forming a printed image.

According to still another aspect of the invention, recorded matter printed by the ink jet recording method is provided.

The invention provides an ink jet treatment liquid that can be ejected by an ink jet method and is adhesive to ink-nonabsorbable recording media and transparent, and that can easily dry after being ejected and prevent printed images from spreading, and has storage stability. Also, it provides an ink jet recording method and recorded matter using the ink jet treatment liquid.

### DESCRIPTION OF EXEMPLARY EMBODIMENTS

The invention will further be described in detail with reference to preferred embodiments.

An ink jet treatment liquid according to an embodiment of the invention contains a cationic polyurethane and a polyamine and/or a polyamine derivative.

This composition can provide an ink jet treatment liquid that can be ejected by an ink jet method and is adhesive to ink-nonabsorbable recording media and transparent, and that can easily dry after being ejected and prevent printed images from spreading, and has storage stability.

Any known cationic polyurethane can be used as the cationic polyurethane of the treatment liquid without particular limitation.

For example, a cationic polyurethane prepared by the following preparation (1) or (2) may be used. The cationic polyurethane is preferably dispersed in water.

The cationic polyurethane can be prepared by preparation (1). Specifically, an urethane prepolymer is prepared using polyisocyanate (A); polyesterpolyol (B1) as a polyol conducting an urethane reaction; and a chain extending agent (C) having a tertiary amino group. The tertiary amino group is partially neutralized with an acid or quaternized with a quaternizing agent so that the amine value is in the range of 1 to 40 (KOH mg/g). Thus, a cationic polyurethane composition can be prepared. Alternatively, the cationic polyurethane may be prepared by preparation (2). Specifically, an urethane prepolymer may be prepared from polycarbonatepolyol (B2), the chain extending agent (C) having a tertiary amino group, and polyalkylene oxide (D) containing 50% by mass or more of ethylene oxide chain with polyisocyanate (A). The tertiary amino group introduced by the chain extending agent (C) is neutralized with an acid or quaternized with a quaternizing agent to yield a cationic polyurethane. The resulting cationic polyurethane may be dispersed in water to prepare a water dispersant.

Preparation (1) will be described below.

Conventionally used aliphatic, alicyclic, aromatic and aroma-aliphatic polyisocyanates can be used as polyisocyanate (A).

Exemplary aliphatic polyisocyanates include tetramethylene diisocyanate, dodecamethylene diisocyanate, 1,4-butane diisocyanate, hexamethylene diisocyanate, 2,2,4-trimethylhexamethylene diisocyanate, 2,4,4-trimethylhexamethylene diisocyanate, lysine diisocyanate, 2-methylpentane-1,5-diisocyanate, and 3-methylpentane-1,5-diisocyanate.

Exemplary alicyclic polyisocyanates include isophorone diisocyanate, hydrogenated xylylene diisocyanate, 4,4′-dicyclohexylmethane diisocyanate, 1,4-cyclohexane diisocyanate, methylcyclohexylene diisocyanate, and 1,3-bis(isocyanatemethyl)cyclohexane.

Exemplary aromatic polyisocyanates include tolylene diisocyanate, 2,2′-diphenylmethane diisocyanate, 2,4′-diphenylmethane diisocyanate, 4,4′-diphenylmethane diisocyanate, 4,4′-diphenyldimethylmethane diisocyanate, 4,4′-dibenzyl diisocyanate, 1,5-naphthylene diisocyanate, xylylene diisocyanate, 1,3-phenylene diisocyanate, and 1,4-phenylene diisocyanate.

Exemplary aroma-aliphatic polyisocyanates include dialkyldiphenylmethane diisocyanate, tetraalkyldiphenylmethane diisocyanate, and α,α,α,α-tetramethylxylylene diisocyanate.

These polyisocyanates may be used singly or in combination.

Polyesterpolyol (B1) can be constituted of various type of polycarboxylic acid and polyol. From a viewpoint of adhesion, preferred are polyesterpolyols prepared from a dicarboxylic acid, such an aliphatic dibasic acid or an aromatic dibasic acid, and an aliphatic glycol. Examples of the aliphatic dibasic acid include malonic acid, succinic acid, tartaric acid, oxalic acid, glutaric acid, adipic acid, pimelic acid, suberic acid, azelaic acid, sebacic acid, alkylsuccinic acid, linolenic acid, maleic acid, fumaric acid, mesaconic acid, citraconic acid, itaconic acid, glutaconic acid, acid anhydrides and alkyl esters of these acids, and acid halides and other reactive derivatives. These aliphatic dicarboxylic acids may be used singly or in combination. Examples of the aromatic dibasic acid include phthalic acid, isophthalic acid, terephthalic acid, 1,4-naphthalenedicarboxylic acid, 2,5-naphthalenedicarboxylic acid, 2,6-naphthalenedicarboxylic acid, biphenyldicarboxylic acid, tetrahydrophthalic acid, acid anhydrides and alkyl esters of these acids, and acid halides and other reactive derivatives. These aromatic dicarboxylic acids may be used singly or in combination.

Examples of the aliphatic glycol include ethylene glycol, diethylene glycol, triethylene glycol, 1,3-propanediol, 1,3-butanediol, 1,4-butanediol, neopentyl glycol, pentanediol, 1,6-hexanediol, and propylene glycol. These aliphatic glycols may be used singly or in combination.

The chain extending agent (C) having a tertiary amino group is added to introduce the tertiary amino group to the urethane prepolymer. Exemplary chain extending agents include N-alkyldialkanolamines, such as N-methyldiethanolamine and N-ethyldiethanolamine; N-alkyldiaminoalkylamines, such as N-methyldiaminoethylamine and N-ethyldiaminoethylamine; and triethanolamine. These chain extending agents (C) may be used singly or in combination.

Preferably, the chain extending agent (C) is added in an amount of 5% to 20% by mass relative to the total of polyisocyanate (A), polyesterpolyol (B1) and chain extending agent (C). If the amount of chain extending agent (C) is less than 5% by mass, the tertiary amino group to be introduced is reduced to degrade the adhesion and water resistance of the resulting ink. If the amount of chain extending agent (C) is more than 20% by mass, the adhesion and the durability are not sufficiently enhanced according to the amount added. In addition, it tends to become difficult to prepare an urethane prepolymer under conditions in which the amount of chain extending agent (C) is increased.

Polyisocyanate (A), polyesterpolyol (B1), and chain extending agent (C) having a tertiary amino group react with one another to produce an urethane prepolymer having a free NCO at the terminal. The free terminal NCO content is preferably in the range of 1% to 5% by mass. If the free terminal NCO content is less than 1%, the preparation of the urethane prepolymer becomes difficult. If the free terminal NCO content is more than 5% by mass, the flocculation of the resulting aqueous polyurethane resin is excessively increased. This is undesirable in view of the adhesion.

The resulting cationic urethane prepolymer has the tertiary amino group introduced by chain extending agent (C), and at least part of the tertiary amino group has been neutralized with an acid or quaternized with a quaternizing agent. For neutralization with an acid, examples of the acid include organic acids, such as formic acid, acetic acid, propionic acid, butyric acid, lactic acid, malic acid, malonic acid, and adipic acid; and inorganic acids, such as hydrochloric acid, phosphoric acid, and nitric acid. These acids may be used singly or in combination.

For quaternization with a quaternizing agent, examples of the quaternizing agent include alkyl halides, such as benzyl chloride and methyl chloride; sulfuric acid esters, such as dimethyl sulfate and diethyl sulfate. These quaternizing agents may be use singly or in combination.

The tertiary amino group is not fully neutralized or quaternized, but partially is. The amount of the tertiary amino group not neutralized or quaternized is such that the cationic polyurethane has an amine value in the range of 1 to 40 (KOH mg/g). The amine value can be controlled by neutralization or quaternization.

Preparation (2) will be described below.

The same polyisocyanate as in preparation (1) is used as polyisocyanate.

Polycarbonate polyol (B2) used in preparation (2) can be prepared by a reaction of a glycol such as 1,4-butanediol, 1,6-hexanediol or diethylene glycol, diphenyl carbonate, and phosgene. Such polycarbonate polyols may be used singly or in combination.

Preferably, polycarbonate polyol (B2) is added in an amount of 40% to 80% by mass relative to the total of polyisocyanate (A), polycarbonate polyol (B2), chain extending agent (C), and polyalkylene oxide (D). If the amount of polycarbonate polyol (B2) is less than 40% by mass, the durability of the resulting urethane resin is degraded, and the adhesion to the film media also tends to be degraded. If the amount of polycarbonate polyol (B2) is more than 80% by mass, the flocculation of resulting cationic polyurethane becomes insufficient, and the durability is degraded as well.

In the embodiment, polyalkylene oxide (D) having an ethylene oxide chain may be used as a constituent of the polyurethane. Polyalkylene oxide (D) is intended to increase the affinity with the ink used for printing. Examples of polyalkylene oxide (D) include ethylene oxide and copolymers of ethylene oxide and propylene oxide. These polyalkylene oxides (D) may be used singly or in combination. If the ethylene oxide chain content in polyalkylene oxide (D) is less than 50% by mass, the affinity with the ink may be degraded.

Preferably, polyalkylene oxide (D) is added in an amount of 3% to 10% by mass relative to the total of polyisocyanate (A), polycarbonate polyol (B2), chain extending agent (C), and polyalkylene oxide (D). An amount of polyalkylene oxide (D) of less than 3% by mass undesirably results in insufficient affinity with the ink. An amount of polyalkylene oxide of more than 10% by mass undesirably results in degraded water resistance.

Chain extending agent (C) used in preparation (2) is the same as in preparation (1).

Preferably, chain extending agent (C) is added in an amount of 5% to 15% by mass relative to the total of polyisocyanate (A), polycarbonate polyol (B2), chain extending agent (C), and polyalkylene oxide (D). If the amount of chain extending agent (C) is less than 5% by mass, the tertiary amino group to be introduced is reduced to degrade the adhesion. If the amount of chain extending agent (C) is more than 15% by mass, the adhesion is not sufficiently enhanced according to the amount added.

At least part of the tertiary amino group introduced by chain extending agent (c) used in preparation (2) is neutralized with an acid or quaternized with a quaternizing agent. The acid and the quaternizing agent are the same as those used in preparation (1).

In preparations (1) and (2), if necessary, polyamine compound (D1) may be added to the cationic urethane prepolymer whose tertiary amino group has been partially neutralized or quaternized when the prepolymer is dispersed in water. Exemplary polyamine compounds used in the preparations have at least two amino groups and include ethylenediamine, propylenediamine, diethylenetriamine, hexylenediamine, triethylenetetramine, tetraethylenepentamine, isophoronediamine, piperazine, diphenylmethanediamine, hydrazine, and hydrazides such as adipic acid dihydrazide.

In preparations (1) and (2), a polyol having at least three hydroxy groups may further be added. The polyol having at least three hydroxy groups can enhance the adhesion to film media. It however must be used in such an amount that does not degrade the dispersibility of the resulting cationic polyurethane in water. Examples of such a polyol include sorbitol, 1,2,3,6-hexanetetraol, 1,4-sorbitan, 1,2,4-butanetriol, 1,2,5-pentanetriol, glycerol, trimethylolethane, trimethylolpropane, and pentaerythritol. These polyols may be used singly or in combination.

The cationic urethane prepolymer produced by partially neutralizing or quaternizing the tertiary amino group is then dispersed in water to yield a dispersion of cationic polyurethane.

The cationic polyurethane may be a resin disclosed in Japanese Unexamined Patent Application Publication Nos. 2002-307811 (paragraphs [0006] to [0048]) and 2002-307812 (paragraphs [0006] to [0053]).

A commercially available cationic polyurethane may be used. Examples of such a cationic polyurethane include: HYDRAN CP-7010, HYDRAN CP-7020, HYDRAN CP-7030, HYDRAN CP-7040, HYDRAN CP-7050, HYDRAN CP-7060 and HYDRAN CP-7610 (produced by DIC Corporation); SUPERFLEX 600, SUPERFLEX 610, SUPERFLEX 620, SUPERFLEX 630, SUPERFLEX 640 and SUPERFLEX 650 (produced by Dai-ichi Kogyo Seiyaku); and Urethane Emulsions WBR-2120C and WBR-2122C (produced by Taisei Fine Chemical).

The cationic polyurethane content in the treatment liquid is preferably 0.5% to 15% by weight, more preferably 1% to 10% by weight, and still more preferably 2% to 8% by weight.

The polyamine and/or polyamine derivative used in the embodiment are not particularly limited and can be selected from known compounds. Examples of the polyamine and/or polyamine derivative include polyallylamine hydrochloride, polyallylamine amidosulfate, allylamine hydrochloride-diallylamine hydrochloride copolymer, allylamine acetate-diallylamine acetate copolymer, allylamine hydrochloride-dimethylallylamine hydrochloride copolymer, allylamine-dimethylallylamine copolymer, polydiallylamine hydrochloride, polymethyldiallylamine hydrochloride, polymethyldiallylamine amidosulfate, polymethyldiallylamine acetate, polydiallyldimethylammonium chloride, diallylamine acetate-sulfur dioxide copolymer, diallylmethylethylammonium ethylsulfate-sulfur dioxide copolymer, methyldiallylamine hydrochloride-sulfur dioxide copolymer, diallyldimethylammonium chloride-sulfur dioxide copolymer, and diallyldimethylammonium chloride-acrylamide copolymer.

A commercially available polyamine and/or polyamine derivative may be used. Examples of such polyamine and polyamine derivative include PAA-HCL-01, PAA-HCL-03, PAA-HCL-05, PAA-HCL-3L, PAA-HCL-10L, PAA-H-HCL, PAA-SA, PAA-01, PAA-03, PAA-05, PAA-08, PAA-15, PAA-15C, PAA-25, PAA-H-10C, PAA-D11-HCL, PAA-D41-HCL, PAA-D19-HCL, PAS-21CL, PAS-M-1L, PAS-M-1, PAS-22SA, PAS-M-1A, PAS-H-1L, PAS-H-5L, PAS-H-10L, PAS-92, PAS-92A, PAS-J-81L and PAS-J-81 (produced by Nitto Boseki); and HYMONEO-600, HYMOLOCK Q-101, HYMOLOCK Q-311, HYMOLOCK Q-501 and HIMAX SC-505 (produced by Hymo).

The polyamine and/or polyamine derivative content in the treatment liquid is preferably 0.1% to 10% by weight, and more preferably 0.5% to 5% by weight.

The treatment liquid of the embodiment may contain a long-chain alkyl glycol ether to enhance the wettability to film media. The long-chain alkyl glycol ether has 5 to 8 alkyl chains, preferably 6 alkyl chains.

Examples of such a long-chain alkyl glycol ether include ethylene glycol mono-n-pentyl ether, ethylene glycol mono-iso-pentyl ether, ethylene glycol mononeopentyl ether, ethylene glycol mono-n-hexyl ether, ethylene glycol mono-iso-hexyl ether, diethylene glycol mono-n-pentyl ether, diethylene glycol mono-iso-pentyl ether, diethylene glycol mononeopentyl ether, diethylene glycol mono-n-hexyl ether, diethylene glycol mono-iso-hexyl ether, triethylene glycol mono-n-pentyl ether, triethylene glycol mono-iso-pentyl ether, triethylene glycol mononeopentyl ether, triethylene glycol mono-n-hexyl ether, triethylene glycol mono-iso-hexyl ether, propylene glycol mono-n-pentyl ether, propylene glycol mono-iso-pentyl ether, propylene glycol mono-neopentyl ether, propylene glycol mono-n-hexyl ether, propylene glycol mono-iso-hexyl ether, dipropylene glycol mono-n-pentyl ether, dipropylene glycol mono-iso-pentyl ether, dipropylene glycol mononeopentyl ether, dipropylene glycol mono-n-hexyl ether, dipropylene glycol mono-iso-hexyl ether, tripropylene glycol mono-n-pentyl ether, tripropylene glycol mono-iso-pentyl ether, tripropylene glycol mononeopentyl ether, tripropylene glycol mono-n-hexyl ether, tripropylene glycol mono-iso-hexyl ether, diethylene glycol mono-2-ethylhexyl ether, triethylene glycol mono-2-ethylhexyl ether, and tetraethylene glycol mono-2-ethylhexyl ether. These glycol ethers may be used singly or in combination.

Among those preferred are ethylene glycol mono-n-hexyl ether, diethylene glycol mono-n-hexyl ether, and propylene glycol mono-n-hexyl ether from the viewpoint of good balance between the wettability to film media and the ease of drying on the film media. Diethylene glycol mono-n-hexyl ether exhibits particularly good balance among the wettability to film media, ease of drying, and solubility in water.

The long-chain alkyl glycol ether content in the treatment liquid is preferably 0.1% to 15% by weight, more preferably 0.5% to 10% by weight, and still more preferably 1% to 5% by weight. If the long-chain alkyl glycol ether content is more than 15% by weight, the treatment liquid cannot easily dry when it is applied onto a film medium. In addition, the solubility in water is reduced, and accordingly the long-chain alkyl glycol ether cannot be dissolved in the treatment liquid.

In order to enhance the wettability to film media, the treatment liquid of the embodiment may contain diacetylene tetraol expressed by general formula (1).

For example, SURFYNOL MD-20 is available from Air Products and Chemicals as the diacetylene tetraol expressed by general formula (1).

While the diacetylene tetraol is greatly advantageous in enhancing the wettability to film media, it cannot be easily dissolved in water and requires use of a solubilizing agent. The above-described long-chain alkyl glycol ethers are effective as the solubilizing agent of diacetylene tetraol. Among those preferred are ethylene glycol mono-n-hexyl ether, diethylene glycol mono-n-hexyl ether, triethylene glycol mono-n-hexyl ether, propylene glycol mono-n-butyl ether, dipropylene glycol mono-n-butyl ether, and tripropylene glycol mono-n-butyl ether. These compounds are effective as a solubilizing agent and exhibit good balance between the wettability to film media and the ease of drying on the film media.

The diacetylene tetraol content in the treatment liquid is preferably 0.01% to 1% by weight, and more preferably 0.05% to 0.5% by weight.

The treatment liquid of the embodiment may contain an alkanediol as a solubilizing agent for the long-chain alkyl glycol ether in water, or in order to enhance the wettability of the resulting treatment liquid to film media or to enhance the clogging resistance. Exemplary alkanediols include water-soluble 1,2-alkanediol and water-soluble alkanediols having a hydroxyl group at both ends.

Preferred water-soluble 1,2-alkanediols include branched or unbranched 1,2-alkanediol having a carbon number of 5 or 6, and specifically 4-methyl-1,2-pentanediol, 1,2-pentanediol, 3,3-dimethyl-1,2-butanediol, and 1,2-hexanediol. Among these, 1,2-hexanediol is particularly suitable as the solubilizing agent for the long-chain alkyl glycol ether in water and suitable to enhance the clogging resistance of the treatment liquid.

The water-soluble 1,2-alkanediol content in the entire treatment liquid is preferably 1% to 10% by weight, and more preferably 2% to 8% by weight. If the content is more than 15% by weight, the water-soluble 1,2-alkanediol cannot easily vaporize and the resulting treatment liquid cannot easily dry on film media.

Preferred water-soluble alkanediol having a hydroxyl group at both ends include branched or unbranched alkanediols having a hydroxyl group at both ends having a carbon number of 3 to 10, and specifically 1,3-propanediol, 1,4-butanediol, 1,5-pentanediol, and 1,6-hexanediol.

The content of water-soluble alkanediol having a hydroxyl group at both ends in the entire treatment liquid is preferably 1% to 15% by weight, and more preferably 2% to 10% by weight. This range can enhance both clogging resistance and ease of drying on film media.

Furthermore, the treatment liquid of the embodiment may contain a penetrating solvent. The penetrating solvent may be at least one type selected from among polyoxyethylene and/or polypropylene chain-added 1,2-alkanediols having a carbon number of 5 to 10, 1,2-alkanediols having a carbon number of 3 to 10, lactams, and lactones.

The treatment liquid may further contain a silicone surfactant, if necessary.

Exemplary silicone surfactants include: SH3746, SH3748, SH3749, SH3771, SH8400, SH8410, SH8427, and SH8700 (available from Dow Corning Toray); TSF4440, TSF4441, and TSF4452 (available from Momentive Performance Materials); and BYK-300, BYK-302, BYK-307, BYK-325, BYK-331, BYK-333, BYK-341, BYK-345, BYK-346, BYK-347, BYK-348, BYK-375, BYK-378, and BYK-UV3500 (available from BYK).

Among these silicone surfactants, polyorganopolysiloxane surfactants are particularly effective in reducing the surface tension of the treatment liquid to enhance the wettability to film media.

Preferably, the organopolysiloxane surfactant contains at least one compound expressed by the following general formula:

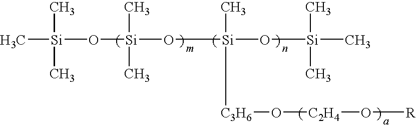

(In the formula, R represents hydrogen or methyl; a represents an integer of 7 to 11; m represents an integer of 20 to 70; and n represents an integer of 2 to 5.)

The use of such a specific organopolysiloxane surfactant makes the resulting treatment liquid effective in smoothing the surface roughness of the coating when the treatment liquid is applied onto film media.

The silicone surfactant content in the treatment liquid is preferably 0.05% to 5% by weight, and more preferably 0.1% to 2% by weight. In particular, when the R of the surf actant is methyl, the silicon surfactant content is preferably set higher than when the R is H.

The treatment liquid may further contain other surfactants, such as fluorine-based surfactant, acetylene glycol-based surfactant, anionic surfactant, nonionic surfactant, and amphoteric surfactant.

Examples of the acetylene glycol-based surfactant include 2,4,7,9-tetramethyl-5-decyne-4,7-diol, 3,6-dimethyl-4-octyne-3,6-diol, 3,5-dimethyl-1-hexyne-3-ol, and 2,4-dimethyl-5-hexyne-3-ol. A commercially available acetylene glycol-based surfactant may be used, such as OLFINEs E1010, STG and Y (produced by Nissin Chemical Industry); and SURFYNOLs 61, 104, 82, 465, 485 and TG (produced by Air Products and Chemicals).

The treatment liquid of the embodiment contains water as a solvent. The water is preferably pure water or ultrapure water, such as ion exchanged water, ultrafiltered water, osmotic water, or distilled water. Particularly preferably, the water is sterilized by irradiating with UV light or adding hydrogen peroxide. Such water prevents occurrence of molds and bacteria for a long term.

The treatment liquid may further contain an organic amine to adjust the pH in an appropriate range. A tertiary amine is preferably used as the organic amine.

Exemplary tertiary amines include alkanolamines, such as triethanolamine and tripropanolamine. Preferably, the pH of the treatment liquid of the embodiment is in the range of 7 to 10, and particularly preferably in the range of 7.5 to 9. In particular, when the pH is increased to more than 12, the storage stability of the treatment liquid is extremely degraded.

The organic amine content in the entire treatment liquid is 0.01% by weight or more. Preferably, it is 0.05% to 5.0% by weight, and more preferably 0.1% to 2.0% by weight from the viewpoint of enhancing the wettability on the recording surface of, for example, recording media to increase the permeability of the ink, and of the ejection stability and storage stability of the treatment liquid and high-speed printing.

Preferably, the treatment liquid further contains a recording medium dissolving agent.

Preferred recording medium dissolving agents include pyrrolidones, such as 2-pyrrolidone and N-methyl-2-pyrrolidone, and lactones, such as γ-butyrolactone. The recording medium dissolving agent content can be appropriately set and preferably in the range of about 0.1% to 30% by weight, more preferably in the range of about 1% to 15% by weight.

In order to enhance the clogging resistance, the treatment liquid of the embodiment may further contain a wetting agent in such an amount that the treatment liquid can easily dry. The wetting agent may be a polyhydric alcohol and/or a saccharide. Examples of the polyhydric alcohol include glycerol, ethylene glycol, diethylene glycol, tirethylene glycol, and trimethylolpropane. Examples of the saccharide include monosaccharides, disaccharides, oligosaccharides (including trisaccharides and tetrasaccharides) and polysaccharides, and more specifically glucose, mannose, fructose, ribose, xylose, arabinose, galactose, aldonic acid, glucitol (sorbitol), maltose, cellobiose, lactose, sucrose, trehalose, and maltotriose. The polysaccharide mentioned herein refers to broad saccharides including naturally occurring substances, such as alginic acid, α-cyclodextrin, and cellulose. Derivatives of these saccharides include their reduced sugars such as sugar alcohols expressed by the general formula HOCH₂(CHOH)nCH₂OH (n: integer of 2 to 5), their oxidized sugars such as aldonic acid and uronic acid, amino acids, and thio sugars. For example, maltitol, sorbitol, or xylitol is used. Also, trimethylolpropane, 1,2,6-hexatriol, or the like may be used.

The wetting agent content is preferably set in the range of about 0.1% to 10% by weight, more preferably in the range of about 0.5% to 5% by weight.

The treatment liquid may further contain other additives, such as nozzle clogging inhibitor, preservative, antioxidant, electric conductivity modifier, viscosity modifier, surface tension modifier, and oxygen absorbent.

Examples of the preservative include sodium benzoate, sodium pentachlorophenol, sodium 2-pyridinethiol-1-oxide, sodium sorbate, sodium dehydroacetate, and 1,2-dibenzinethiazoline-3-one (Proxel CRL, Proxel BND, Proxel GXL, Proxel XL-2, and Proxel TN available from ICI).

Examples of a solubilizing agent or the antioxidant include alcohols, such as ethanol, propanol, and butanol; amines, such as diethanolamine and morpholine, and their modified products; inorganic hydroxides, such as potassium hydroxide, sodium hydroxide, and lithium hydroxide; ammonium hydroxide and quarternary ammonium hydroxides (for example, tetramethylammonium hydroxide); carbonates, such as potassium carbonate, sodium carbonate, and lithium carbonate, and their salts; ureas, such as N-methyl-2-pyrrolidone, 2-pyrrolidone, urea, thio urea, and tetramethyl urea; allophanates, such as allophanate and methyl allophanate; biurets, such as biuret, dimethyl biuret, and tetramethyl biuret; and L-ascorbic acid and its salts.

The treatment liquid of the embodiment may further contain an antioxidant and an UV light absorber, such as Tinuvins (328, 900, 1130, 384, 292, 123, 144, 622, 770, and 292), Irgacors (252 and 153), and Irganoxs (1010, 1076, 1035, and MD 1024) produced by CIBA Specialty Chemicals; and lanthanide oxide.

According to an embodiment of the invention, an ink jet recording method is provided in which printed images are formed by ejecting ink jet recording ink droplets onto a recording medium that has been treated with the ink jet treatment liquid. This method prevents printed images from spreading even on an ink-nonabsorbable recording medium.

According to an embodiment of the invention, recorded matter printed by the ink jet recording method is provided. In this recorded matter, printed images do not spread even though the images are printed on an ink-nonabsorbable recording medium.

The invention will be further described in detail with reference to Examples. The invention is not however limited to the examples. In the following description, part(s) refers to part(s) by weight unless otherwise specified.

### EXAMPLE 1

In Example 1, HYDRAN CP-7010 (produced by DIC Corporation) was used as the cationic polyurethane, and PAA-01 (produced by Nitto Boseki) was used as the polyamine and/or polyamine derivative.

Composition of Treatment Liquid 1

HYDRAN CP-7010 (solid content, 30%): 15 parts

PAA-01 (solid content, 15%): 10 parts

ethylene glycol mono-n-hexyl ether: 0.5 part

1,2-pentanediol: 4 parts

BYK-347: 0.3 part

N-methyl-2-pyrrolidone: 10 parts

triethanolamine: 0.5 part

water: balance

These materials were sufficiently agitated and mixed, and the mixture was filtered through a membrane filter having a pore size of 10 μm to yield Treatment Liquid 1.

### EXAMPLE 2

In Example 2, HYDRAN CP-7020 (produced by DIC Corporation) was used as the cationic polyurethane, and PAS-A-1 (produced by Nitto Boseki) was used as the polyamine and/or polyamine derivative.

Composition of Treatment Liquid 2

HYDRAN CP-7020 (solid content, 40%): 10 parts

PAS-A-1 (solid content, 24%): 5 parts

diethylene glycol mono-n-hexyl ether: 2.5 parts

1,2-hexanediol: 3 parts

BYK-348: 0.5 part

N-methyl-2-pyrrolidone: 10 parts

tripropanolamine: 0.5 part

water: balance

These materials were sufficiently agitated and mixed, and the mixture was filtered through a membrane filter having a pore size of 10 μm to yield Treatment Liquid 2.

### EXAMPLE 3

In Example 3, HYDRAN CP-7050 (produced by DIC Corporation) was used as the cationic polyurethane, and PAS-J-81L (produced by Nitto Boseki) was used as the polyamine and/or polyamine derivative.

Composition of Treatment Liquid 3

HYDRAN CP-7050 (solid content, 25%): 36 parts

PAS-J-81L (solid content, 25%): 4 parts

propylene glycol mono-n-hexyl ether: 0.5 part

1,2-pentanediol: 4 parts

BYK-348: 0.5 part

N-methyl-2-pyrrolidone: 8 parts

triethanolamine: 0.5 part

water: balance

These materials were sufficiently agitated and mixed, and the mixture was filtered through a membrane filter having a pore size of 10 μm to yield Treatment Liquid 3.

### EXAMPLE 4

In Example 4, HYDRAN CP-7030 (produced by DIC Corporation) was used as the cationic polyurethane, and PAA-HCL-05 (produced by Nitto Boseki) was used as the polyamine and/or polyamine derivative.

Composition of Treatment Liquid 4

HYDRAN CP-7030 (solid content, 22%): 20 parts

PAA-HCL-05 (solid content, 40%): 10 parts

ethylene glycol mono-n-hexyl ether: 1 part

1,2-hexanediol: 4 parts

SURFYNOL MD-20: 0.1 part

BYK-348: 0.5 part

N-methyl-2-pyrrolidone: 10 parts

tripropanolamine: 0.5 part

ethanol: 3 parts

water: balance

These materials were sufficiently agitated and mixed, and the mixture was filtered through a membrane filter having a pore size of 10 μm to yield Treatment Liquid 4.

### EXAMPLE 5

In Example 5, SUPERFLEX 650 (produced by Dai-ichi Kogyo Seiyaku) was used as the cationic polyurethane, and PAS-A-5 (produced by Nitto Boseki) was used as the polyamine and/or polyamine derivative.

Composition of Treatment Liquid 5

SUPERFLEX 650 (solid content, 25%): 40 parts

PAS-A-5 (solid content, 40%): 2 parts

ethylene glycol mono-n-hexyl ether: 4 parts

1,2-pentanediol: 5 parts

BYK-348: 0.5 part

N-methyl-2-pyrrolidone: 8 parts

triethanolamine: 0.5 part

water: balance

These materials were sufficiently agitated and mixed, and the mixture was filtered through a membrane filter having a pore size of 10 μm to yield Treatment Liquid 5.

### EXAMPLE 6

In Example 6, SUPERFLEX 650 (produced by Dai-ichi Kogyo Seiyaku) was used as the cationic polyurethane, and PAA-05 (produced by Nitto Boseki) was used as the polyamine and/or polyamine derivative.

Composition of Treatment Liquid 6

SUPERFLEX 650 (solid content, 25w): 8 parts

PAA-05 (solid content, 20%): 2.5 parts

diethylene glycol mono-n-hexyl ether: 2 parts

1,2-hexanediol: 6 parts

BYK-347: 0.5 part

N-methyl-2-pyrrolidone: 10 parts

tripropanolamine: 0.5 part

water: balance

These materials were sufficiently agitated and mixed, and the mixture was filtered through a membrane filter having a pore size of 10 μm to yield Treatment Liquid 6.

### EXAMPLE 7

A treatment liquid of Example 7 was prepared in the same manner as in Example 1, except that ethylene glycol mono-n-hexyl ether was replaced with ethylene glycol mono-n-butyl ether.

### COMPARATIVE EXAMPLE 1

A treatment liquid of Comparative Example 1 was prepared in the same manner as in Example 1, except that the polyamine and/or polyamine derivative PAA-01 (produced by Nitto Boseki) was not used and replaced with water.

### COMPARATIVE EXAMPLE 2

A treatment liquid of Comparative Example 2 was prepared in the same manner as in Example 1, except that the cationic polyurethane HYDRAN CP-7010 (produced by DIC Corporation) was not used and replaced with water.

### COMPARATIVE EXAMPLE 3

A treatment liquid of Comparative Example 3 was prepared in the same manner as in Example 1, except that the polyamine and/or polyamine derivative PAA-01 (produced by Nitto Boseki) was not used and replaced with magnesium sulfate.

### Evaluation of Coating

An ink jet printer PX-G930 (manufactured by Seiko Epson) was filled with the treatment liquid, and the treatment liquid was printed on the entire surface of a PET film at an amount per unit area of (1) 3 g/m² or (2) 5 g/m². After printing, the PET film was dried for about 1 minute in a thermostatic chamber of 60° C. After being dried, the surface of the coating was observed through a microscope of a magnification of 50 times, and the coating state was evaluated.

A: The treatment liquid was uniformly applied over the surface of the PET film.

B: A little striped unevenness was observed in the coating of the treatment liquid on the PET film.

C: Conspicuous unevenness of the coating was observed on the PET film.

### Evaluation of Abrasion Resistance

After the evaluation of coating, the PET film was rubbed with BENCOT M-3 (manufactured by OZU Corporation) for evaluation of abrasion resistance. For rubbing, BENCOT was folded in eight. The surface of the coating was rubbed five times with a corner of the folded BENCOT at a load of about 300 gf, and the state of the coating was evaluated according to the following criteria:

A: Rubbing marks were hardly observed in visual test.

B: A little rubbing mark was visually observed.

C: separation of the coating of the treatment liquid was visually observed at the portion rubbed with BENCOT.

### Evaluation of Reactivity

A PET sheet was coated with the treatment liquid in the same manner as in the evaluation of abrasion resistance. After drying, a maker's specified ink for ink jet printer PX-G930 (manufactured by Seiko Epson) was printed on the surface of the treatment liquid coating over the PET sheet. The spreading and bleeding of printed images were evaluated according to the following criteria:

A: There was no spreading or bleeding of printed images.

B: A little spreading or bleeding of printed images was observed.

C: Conspicuous spreading or bleeding of printed images was observed.

### Evaluation of Storage Stability

The treatment liquid was placed in a glass bottle and allowed to stand at 60° C. for 1 week. Then, it was visually observed whether foreign matter (suspended matter or sediment) was present. When foreign matter was not produced, the treatment liquid was subjected to examinations for changes of physical properties (viscosity, surface tension, pH, and particle size) Thus, the storage stability was evaluated according to the following criteria:

A: Foreign matter was not produced or physical properties were not changed.

B: Foreign matter was not produced, but physical properties were slightly changed.

C: Foreign mater was produced and physical properties were extremely changed.

### Evaluation of Clogging

An ink jet printer PX-G930 (manufactured by Seiko Epson) was filled with the treatment liquid. After the liquid could be appropriately ejected through all the nozzles, the operation of the ink jet printer was stopped and the printer was allowed to stand at 40° C. for 24 hours with the printer head uncovered. Then, cleaning was repeated until the treatment liquid was ejected again. Thus, the recovery from clogging was evaluated according to the following criteria:

A: All the nozzles were recovered after two cycles or less of cleaning.

B: All the nozzles were recovered after three to five cycles of cleaning.

C: All the nozzles were not recovered even after six cycles of cleaning.

The following table shows the results of the above evaluations.

TABLE

| | Exam- | Exam- | | | | | | Comparative | Comparative | Comparative |
|---|---|---|---|---|---|---|---|---|---|---|
| | ple 1 | ple 2 | Example 3 | Example 4 | Example 5 | Example 6 | Example 7 | Example 1 | Example 2 | Example 3 |
| Coating (1) | B | A | B | A | A | A | C | B | C | C |
| Coating (2) | A | A | A | A | A | A | B | A | B | B |
| Abrasion | A | A | A | A | A | B | A | B | C | C |
| resistance (1) | | | | | | | | | | |
| Abrasion | A | A | A | A | A | A | A | B | C | B |
| resistance (2) | | | | | | | | | | |
| Reactivity (1) | A | A | A | A | A | A | A | C | C | B |
| Reactivity (2) | A | A | A | A | A | A | A | C | B | A |
| Storage | A | A | B | A | B | A | A | A | A | C |
| stability | | | | | | | | | | |
| Clogging | B | A | B | A | B | A | B | B | A | C |

(1) ejection amount per unit area: 3 g/m²
(2) ejection amount per unit area: 5 g/m²

The ink jet treatment liquid of the invention can be ejected by an ink jet method and is adhesive to ink-nonabsorbable recording media and transparent, and that can easily dry after being ejected and prevent printed images from spreading, and has storage stability. Also, the ink jet recording method and recorded matter using the ink jet treatment liquid are advantageous in the industry.

What is claimed is:

1. An ink jet treatment liquid comprising: a cationic polyurethane and a polyamine and/or a polyamine derivative.

2. The ink jet treatment liquid according to claim 1, further comprising a long-chain alkyl glycol ether.

3. The ink jet treatment liquid according to claim 1, further comprising a diacetylene tetraol expressed by general formula (1): 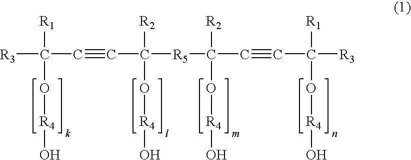
where R₁ and R₂ each represent an alkyl group having a carbon number in the range of 1 to 8; R₃ represents hydrogen or methyl; —O—R₄— independently represents one of oxyethyl, oxypropyl, and oxybutyl; R₅ represents a divalent linking group; and k, l, m, and n each represent an integer in the range of 1 to 100.

4. The ink jet treatment liquid according to claim 1, further comprising 1,2-alkanediol.

5. The ink jet treatment liquid according to claim 1, further comprising a silicone surfactant.

6. An ink jet recording method comprising ejecting an ink jet recording ink onto a recording medium treated with the ink jet treatment liquid as set forth in claim 1, thereby forming a printed image.

7. Recorded matter printed by the ink jet recording method as set forth in claim 6.
